(19) United States
(12) Patent Application Publication
(10) Pub. No.: US 2026/0084540 A1
(43) Pub. Date: Mar. 26, 2026

(54) SYSTEM COMPRISING AT LEAST ONE ELECTRICALLY PROPELLABLE VEHICLE

(71) Applicant: EVIAS AB, Stockholm (SE)

(72) Inventor: Gunnar ASPLUND, Solna (SE)

(73) Assignee: EVIAS AB, Stockholm (SE)

(21) Appl. No.: 19/108,703

(22) PCT Filed: Sep. 5, 2023
(86) PCT No.: PCT/EP2023/074311

§ 371 Date: Mar. 4, 2025

(30) Foreign Application Priority Data
Sep. 5, 2022 (SE) 2251017-6

(51) Int. Cl. B60L 5/40; B60L 53/30; B60L 53/62; B60L 53/63; B60L 53/65; B60L 53/66; B60M 1/34; B60M 7/00

(52) U.S. Cl. CPC B60L 5/40; B60L 53/305; B60L 53/32; B60L 53/62; B60L 53/63; B60L 53/65; B60L 53/66; B60M 1/34; B60M 7/003; B60L 2200/26

(57) ABSTRACT

A system includes electrically propellable road vehicle(s) and electric conductors extending along a road, at least one electric conductor being formed by at least two consecutive conductor segments. The road vehicle(s) includes at least one electric motor, an electric energy storage device and a current collector adapted to connect electrically with the electric conductor(s). The system includes at least two vehicle external charging devices, each connected to conductor segment(s), and charging device control means configured to control the charging device(s), said charging device control means provided with communication means. Each road vehicle includes vehicle control means and communication means adapted to connect with the communication means of the charging device control means to transmit a charge signal indicative of a desired charging current, the charging device control means configured to, in response, order a charging device to provide a current to the connected conductor segment(s) corresponding to the desired current.

### TECHNICAL FIELD

The invention relates to the field of supplying electric power to electrically propellable vehicles for charging and optionally propulsion thereof.

### BACKGROUND

Concerns about the environmental impact of combustion of fossil fuels have led to an increased interest in electric vehicles, which have several potential benefits compared to vehicles with conventional internal combustion engines, including: a significant reduction of urban air pollution, as they do not emit harmful tailpipe pollutants from the on-board source of power at the point of operation; reduced greenhouse gas emissions from the on-board source of power, depending on the fuel and technology used for electricity generation and/or charging the batteries and reduced dependency on fossil fuels with increasingly variable supply and fluctuating prices.

Presently, electric vehicles are normally charged at stationary charging stations located at parking lots (public or at the home of the vehicle owner) or at rest stops along the highways. Although the latest-generation electric vehicles are provided with high-voltage fast charging technology, charging of the vehicles still takes significantly longer time compared to fuelling a vehicle with fossil fuels. The lengthy charging times also often cause queues at the charging stations during peak hours, thus adding even further to the overall time needed to charge the vehicles.

WO 2011/123049 proposes complementing the battery of the electric vehicle with electric feeding of the vehicle while driving. A system is disclosed for electric propulsion of a vehicle along a road comprising rail elements/structures having grooves provided with electric conductors therein that may be put under voltage and located in longitudinal tracks or channels in the road. The vehicle is equipped with a current collector which during contact with the electric conductors allows for transfer of electric power between the electric conductors and the vehicle to propel the vehicle and charge its battery set. To account for different voltages and charging currents required for different vehicles, each vehicle is provided with an on-board charger to control the charging voltage and current to the battery set. Such an onboard charger adds cost and typically for a truck weights several hundreds of kg to provide sufficient power for a truck/heavy vehicle (while still not being able to provide “fast charging”) consequently reducing the payload of the vehicle. A further disadvantage with such a system is that significant investments in infrastructure is required to provide electric conductors along a sufficiently large part of the road network.

### SUMMARY

An object of the invention is to provide an improved system and method which at least partly solves or at least improves on the problems identified in the background section above.

These and other objects are achieved by the present invention by means of a system and a method according to the independent claims.

According to a first aspect of the invention, there is provided a system for charging an electric storage device of at least one electrically propellable vehicle and optionally also for providing electric power to the vehicle for propulsion thereof. The system comprises at least two electric conductors extending along a road section on which the vehicle is adapted to travel, at least one electrically propellable vehicle, at least two vehicle external charging devices, and charging device control means. At least one, or each, electric conductor is formed by at least two conductor segments arranged consecutively along a lengthwise direction of the road section, said conductor segments being electrically isolated from each other. The at least one electrically propellable vehicle each comprises at least one electric motor arranged to propel the vehicle, an electric energy storage device (such as a battery set) electrically connected with the at least one electric motor and a current collector adapted to connect electrically with said at least two electric conductors, the current collector being electrically connected to the electric energy storage device. The current collector may be electrically connected to the electric energy storage device via switching means. The charging devices are connected to two or more electric conductors to provide a voltage (usually DC voltage) thereto adapted for charging the electric energy storage device of the at least one electrically propellable vehicle. Each charging device is connected to one or more conductor segment. The charging device control means is/are configured to control the at least one vehicle external charging device, said charging device control means being provided with communication means. Each electrically propellable vehicle comprises vehicle control means and vehicle communication means adapted to connect with the communication means of the charging device control means to transmit at least one charge signal thereto indicative of at least one charging parameter comprising a desired charging current for the electric energy storage device of the vehicle. The charging device control means is/are configured to, in response to said charge signal, order one, or at least one, of the at least one vehicle charging devices to provide a current to a thereto connected conductor segment corresponding to the desired charging current. At least two, or each, of the at least two electric conductors extending along a road section may be arranged in parallel.

In other words, the system comprises at least two electric conductors extending along a road section on which the vehicle is adapted to travel. One (or more) of the electric conductors may be connected or connectable to ground potential, which may thus be referred to as ground conductor(s). One or more, or each, of the electric conductor(s) may be arranged in or on a rail element, for example recessed in groove(s) of the rail element, which thus may be referred to as a slotted element. The rail/slotted element may be fully or partly recessed in the road surface, arranged on the road surface or may be suspended above or beside the road surface. Alternatively, the conductors may be suspended above or besides the road surface without being arranged in/on a rail element. At least one, or each, electric conductor is formed by at least two conductor segments arranged consecutively along a lengthwise direction of the road section, said conductor segments being electrically isolated from each other. In the embodiment where one or more of the electric conductors are connected to ground, these ground conductor(s) may be formed by segments but this is normally not the case. The at least two vehicle external charging devices are vehicle-external in the sense that the charging devices are arranged stationary relatively the road. The current collector of the at least one electrically propellable vehicle may be displaceable vertically and laterally to connect mechanically and electrically with the at least two electric conductors. Such displacement is described in applicant's previous patents and will not be described in further detail here.

In embodiments with two or more segmented electric conductors, at least one, or each, charging device may be connected to at least one conductor segment of the two or more electric conductors, i.e. to two or more conductor segments. Alternatively, if one or more of the electric conductors is not segmented, at least one, or each, charging device may be connected to at least one conductor segment of one or more electric conductors and to one or more non-segmented electric conductor. In embodiments with one or more electric conductors connected to ground and one or more electric conductor comprising conductor segments, each charging device may be connected to at least one conductor segment of the one or more electric conductor comprising conductor segments and to the one or more ground conductors. Each charging device thereby provides electric power thereto adapted for charging the electric energy storage device of the at least one electrically propellable vehicle.

In embodiments, the system comprises two electric conductors, where a first electric conductor is segmented, and the second electric conductor is connected to ground (i.e. forms a ground conductor). Charging devices are connected to the ground conductor and to the conductor segments of the first electric conductor.

The charging devices may comprise a dc-dc converter arranged to provide the desired charging current. Such dc-dc converters are normally fed from a transformer arrangement connected to the grid via a rectifier arrangement. The rectifier arrangement and optionally also the transformer arrangement may be considered part of the charging devices or may be separate and be connected to several charging devices.

The charging devices may also comprise one or more switching devices connected between the dc-dc converter and one or more conductor segments. The switching devices may be arranged together with the dc-dc converter at distributed locations along the road section, alternatively, the dc-dc converter may be arranged together with the transformer and rectifier arrangement at transformer stations arranged at longer distances from each other, while the switching devices are arranged at said distributed locations. Alternatively, the switching devices, dc-dc converters and the transformer and rectifier arrangement are arranged at said transformer stations.

The charging device control means is/are configured to control the at least one vehicle external charging device, said charging device control means being provided with communication means. It is understood that the charging device control means may comprise a centrally arranged control unit (arranged for instance at a transformer station) which controls a plurality charging devices connected to respective conductor segments, or may comprise distributed control units, each controlling one or more charging devices, for example one charging control unit for each charging device which may be arranged at said distributed locations along the road section.

The vehicle control means of the vehicle(s) may comprise or be formed as a separate control unit or be integrated as software in another electronic control unit of the vehicle. The charging device control means is/are configured to, in response to said charge signal, order one of the at least one vehicle charging devices to provide a current to thereto connected conductor segment(s) corresponding to the desired charging current. It is understood that the charging device control means ordering one of the charging devices may comprise transmitting an order signal to the charging device indicative the desired charging current.

The invention is based on the insight that by providing vehicle-external charging devices connected to at least two electric conductors, rather than having on-board chargers on each vehicle, the charging power can be significantly increased since weight, size and cost of the chargers are of much less concern. The invention is further based on the insight that such higher charging power allows the vehicles to be charged over a shorter driving distance, which means that the electric conductors extending along the road sections need to cover a smaller portion of the road network which lowers the cost proportionally. In particular, it is envisioned that the electric conductors need only to extend along sidings (turnouts/sideroads/lay-bys) of the highways or other roads, where the vehicles may be driven at a lower speed to allow the vehicle to be charged over a relatively short distance. Consequently, the vehicles may be fast charged while driving.

In embodiments, the charging devices are configured to provide DC charging at a power of at least 25 kW, preferably at least 50 kW, or at least 150 kW. Such power levels may be referred to as “fast charging”.

In embodiments, the communication means of the charging device control means and the vehicle communication means are wireless communication means, for instance radio frequency transmitters/receivers using for instance the GSM, 3G, 4G or 5G standard.

In other embodiments, the communication means of the charging device control means comprises a communication interface connected to at least two of the electric conductors, and the vehicle communication means comprises a communication interface connected to the current collector. Thus, in these embodiments, the charging device control means communicates with the vehicle control means via the electric conductors extending along the road section. The communication interfaces may be configured to transmit/receive high frequency signals via the at least two electric conductors and the current collector.

In embodiments, all or a sub-set of said plurality of vehicle external charging devices are each connected solely to one or more conductor segments having a corresponding position in a lengthwise direction. Thus, in embodiments with two or more segmented electric conductors, all or a sub-set of the charging devices are each connected solely to two or more conductor segments having a corresponding position in a lengthwise direction. In embodiments with only one segmented electric conductor (i.e. comprising one or more non-segmented electric conductors such as a ground conductor), all or a sub-set of the charging devices are each connected solely to the non-segmented electric conductor(s) and to one or more conductor segments of the segmented electric conductor(s) having a corresponding position in a lengthwise direction. These embodiments may be advantageous since having a “dedicated” charging device for each conductor segment or pair/set of conductor segments having a corresponding position in the lengthwise direction means that vehicles can be charged from each lengthwise segment, thus allowing charging also during dense traffic.

In embodiments, a first sub-set of said plurality of vehicle external charging devices are each connected solely to one or more conductor segments having a corresponding position in a lengthwise direction (in the sense described above), and wherein a second sub-set of said plurality of vehicle external charging devices are each connected to two or more conductor segments having different positions in a lengthwise direction, wherein a maximum charging power of the first sub-set of said plurality of vehicle external charging devices differs from a maximum charging power of the second sub-set of said plurality of vehicle external charging devices. These embodiments may be advantageous since a larger number of lower power/cost charging devices (the first sub-set) may be provided as dedicated chargers solely for conductor segments(s) at one longitudinal position, and fewer higher power/cost charging devices (the second sub-set) may be provided connected to conductor segments at two or more longitudinal positions. Consequently, a large number of vehicles (such as passenger cars) can each be charged at a lower power by the first sub-set of charging devices while fewer vehicles (such as heavy trucks) can be charged at a higher power by the second sub-set of charging devices. Thus, the system can be optimized to the (usually consistent) vehicle population with regard to charging capacity and cost.

In embodiments, each vehicle control means is configured to transmit an identification signal indicative of the identity of the vehicle to the charging device control means. The identity may be a unique identification number of the vehicle such as a registration number or a chassis number. Alternatively, the identity may be an identification number assigned by the charging device control means to the respective vehicle. The identification signal may be used for authenticating that the vehicle is permitted to receive charging, or for billing purposes.

In embodiments, each current collector is provided with transmitting means. Furthermore, at least one conductor segment is provided with receiving means, wherein the identification signal is transmitted from the vehicle control means to the charging device control means via said transmitting means and said receiving means, wherein the receiving means is arranged at a predetermined position of the respective conductor segment, and wherein the vehicle control means is configured to, over its vehicle communication means, transmit a speed signal indicative of the speed at which the vehicle is travelling to the charging device control means, wherein the charging device control means is configured to determine an initial position of a vehicle being connected to the at least two electric conductors based on the respective predetermined position of the at least one conductor segment and determine a current position of each vehicle being connected to the at least two electric conductors based on said initial position and said speed signal. It is understood that the receiving means has a limited/short extension in the lengthwise direction in order to accurately be able to determine the initial position. For example, the length of the receiving means may be 20 cm or less. The receiving means may be positioned at an end of the respective conductor segment, as seen in the lengthwise direction of the conductor segment. This allows the system to very accurately determine when a vehicle is approaching a subsequent conductor segment.

The transmitting means may be partly formed by the current collector and the receiving means may comprise at least one coil arranged at said predetermined position of the conductor segment, such that a current induced in the current collector is sensed by the at least one coil. Alternatively, the receiving means may be formed as a sub-segment of the conductor segment, wherein the identification signal is a high-frequency signal superimposed on the DC voltage.

In other embodiments, the vehicle control means of at least one, or each, vehicle is furthermore configured to, over its vehicle communication means, transmit a position signal to said charging device control means, which is configured to determine a current position of each vehicle being connected to the at least two electric conductors based on said position signal.

In embodiments, the system comprises at least two electrically propellable vehicles, wherein the current collector is electrically connected to the electric energy storage device via switching means, wherein the charging device control means is configured to
determine, for at least one or preferably each conductor segment, a vehicle to receive charging as the vehicle having a current position corresponding to the conductor segment having travelled farthest along the conductor segment;
order a vehicle charging device connected to the conductor segment to provide a current to the conductor segment corresponding to the charging signal received from the vehicle determined to receive charging, and
transmit an approval signal solely to the vehicle communication means of the vehicle determined to receive charging indicating that electric power is provided, wherein the vehicle control means is configured to, in response to said approval signal, switch on the switching means to connect the current collector to the electric energy storage device for charging thereof.

Put differently, the charging device control means is configured to, for at least one, or preferably each, conductor segment determine a set of vehicles having a current position (which may be determined as described above) corresponding to the conductor segment, i.e. lying within the lengthwise interval of the conductor segment. The vehicle of this set of vehicles which is the vehicle to receive charging is determined as the vehicle which first entered the conductor segment, i.e. having travelled farthest, i.e. having the current position being closest to the end of the conductor segment.

The charging device control means is preferably configured to repeatedly determine, order and transmit as described above, i.e. repeat these steps at a certain frequency. Consequently, the charging device control means can at all times determine which vehicles are positioned at each conductor segment, and make sure that one of these vehicles (the vehicle which first entered the conductor segment) receives charging, and when this “first vehicle” leaves the conductor segment, the following vehicles receives charging.

The approval signal may be transmitted also indicating, or along with an additional signal indicating, the identification number of the vehicle determined to receive charging such that solely that vehicle starts charging.

In embodiments, the vehicle control means is furthermore configured to, via its vehicle communication means, transmit a charge status signal indicative of a current charge status of the electric energy storage device to the charging device control means, and wherein the charging device control means is configured to determine, in response to received charge status signals from two or more vehicles having positions corresponding to the same conductor segment, a set of vehicles which have a current charge status below a predetermined value (such as 80% or 90% charge status), wherein said vehicle to receive charging is determined as the vehicle of said set of vehicles having travelled farthest along the conductor segment. In other words, the vehicle control means is configured to stop charging of the vehicle determined to receive charging when the current charge status has reached a predetermined value, and instead start charging of the following vehicle, i.e. the vehicle which was second to enter the conductor segment (assuming that it has a current charge status below the predetermined value, and if not the third vehicle and so on).

In a simplified embodiment, the charging device control means is not necessarily configured to determine initial and current positions, but is instead configured to determine, based on an identification signal received from receiving means disposed at an end of the conductor segment that the vehicle is about to enter a subsequent conductor segment, and determine if another vehicle is presently receiving charging from the subsequent conductor segment, and if not, determine that the vehicle about to enter the subsequent conductor segment is to receive charging, order the vehicle charging device connected to the subsequent conductor segment to provide a current to the conductor segment corresponding to the charging signal received from the vehicle to receive charging, and optionally transmit an approval signal to the vehicle communication means of the vehicle determined to receive charging indicating that electric power is provided, wherein the vehicle control means is configured to, in response to said approval signal, switch on the switching means to connect the current collector to the electric energy storage device for charging thereof.

In embodiments, at least one charging device is configured to measure the voltage provided therefrom to a thereto connected conductor segment, and wherein said charging device control means is configured to, if said current provided to said conductor segment from said charging device is above a predetermined value determined as a function of said measured voltage, order the charging device to decrease the current provided to the thereto connected conductor segment to the predetermined value. For example, if the measured (DC) voltage is 800 V, the predetermined (maximum) value of the current may be 1200 A, and for 400 V, 300 A. Consequently, if a vehicle having a 400V battery set accidentally enters (with its switching means on) a conductor segment which charging device has erroneously been ordered to supply a current of for example 1200 A, the voltage is measured to 400 V, which means that the predetermined maximum current is exceeded, whereby current is instantaneously reduced to the predetermined value in order not to damage the 400V battery set.

In embodiments, the charging device control means and the vehicle control means of at least one electrically propellable vehicle are configured to charge the at least one electrically propellable vehicle while driving along said road section, and during standstill.

In embodiments, the vehicle control means is configured to transmit a charge signal corresponding to the sum of the maximum allowable charging current of the electric energy storage device and a present power required for propulsion of the vehicle. Such a charge signal is advantageously transmitted if the vehicle is charging while driving to allow maximum charging of the electric energy storage device also under such circumstances.

In embodiments, the charging device control means and the vehicle control means are configured to communicate using standard protocols defined for stationary charging, such as for example CCS2.

According to a second aspect of the invention, there is provided a method for providing electric power to at least one electrically propellable road vehicle from at least two electric conductors extending along a road section on which the vehicle is adapted to travel. At least one, or each, electric conductor is formed by at least two conductor segments arranged consecutively along a lengthwise direction of the road section, said conductor segments being electrically isolated from each other. The at least one electrically propellable vehicle each comprises at least one electric motor arranged to propel the vehicle, an electric energy storage device electrically connected with the at least one electric motor and a current collector being electrically connected to the electric energy storage device, the current collector being adapted to connect electrically with said at least two electric conductors. At least two vehicle external charging devices are each connected to two or more conductor segments of at least two segmented electric conductors, or to one or more conductor segments of a segmented electric conductor and one or more non-segmented electric conductor, to provide a voltage thereto adapted for providing electric power to the at least one electrically propellable vehicle (for charging of the electric energy storage device, and optionally for propulsion thereof). The method comprises determining at least one charging parameter comprising a desired charging current for one or more of the at least one electrically propellable road vehicle; and ordering at least one, or one, of the at least one vehicle charging devices to provide a current to the thereto connected conductor segment or conductor segments corresponding to the desired charging current.

In embodiments of the method, the desired charging current is determined as described above with reference to the system according to the first aspect of the invention, i.e. the vehicle transmits at least one charge signal indicative of at least one charging parameter comprising a desired charging current for the electric energy storage device of the vehicle (for instance using vehicle control means and communication means adapted to connect with communication means of charging device control means). Furthermore, ordering one of the at least one vehicle charging devices may comprise, using charging device control means to, in response to said charge signal, order one of the at least one vehicle charging devices to provide a current to the thereto connected conductor segment or conductor segments corresponding to the desired charging current.

The features of the embodiments described above are combinable in any practically realizable way to form embodiments having combinations of these features. Further, all features and advantages of embodiments described above with reference to the first aspect of the invention may be applied in corresponding embodiments of the system according to the second aspect of the invention and vice versa. In particular, it is noted that embodiments of the method corresponding to embodiments of the system may comprise method steps corresponding to the actions the vehicle control means and charging device control means being configured to take in embodiments of the system.

### BRIEF DESCRIPTION OF THE DRAWINGS

Above discussed and other aspects of the present invention will now be described in more detail using the appended drawings, which show presently preferred embodiments of the invention, wherein:

FIG. 1 shows an embodiment of a system according to the first aspect of the invention, where four conductor segments of an electric conductor shown along with a corresponding charging device;

FIG. 2 shows an embodiment of a system according to the first aspect of the invention, shown without the at least one vehicle;

FIG. 3 shows a prior art system where the vehicle is provided with an on-board charger;

FIG. 4 shows an embodiment of a system according to the first aspect of the invention, the system being provided with a set of four charging devices, each being connected to four (pairs of) conductor segments via switching means;

FIG. 5 shows an embodiment of a system according to the first aspect of the invention, the system being provided with a first sub-set of charging devices each connected solely to one conductor segment and a second sub-set of charging devices comprising a charging device connected to two subsequent conductor segments.

FIG. 6 shows an embodiment of a system according to the first aspect of the invention, the system being provided with a first sub-set of charging devices each connected solely to one conductor segment and a second sub-set of charging devices comprising a charging device connected to a plurality of subsequent conductor segments, the system being shown without the at least one vehicle;

FIG. 7 shows an embodiment of a system according to the first aspect of the invention, wherein the electric conductor comprises a short conductor segment arranged between two longer conductor segments for positioning purposes, and

FIG. 8 shows an embodiment of a system according to the first aspect of the invention, wherein the electric conductors each comprise one or more coils arranged at an end position of the conductor segments for positioning purposes.

### DETAILED DESCRIPTION

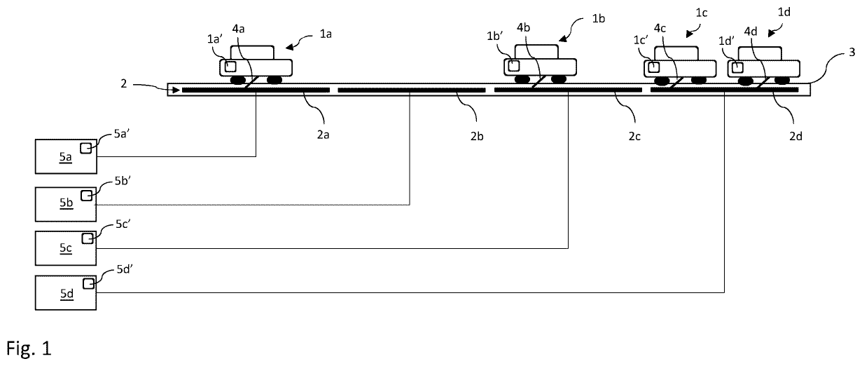

FIG. 1 shows an embodiment of a system according to the first aspect of the invention. The system comprises a plurality of electrically propellable vehicles, in the figure vehicles 1a-d are shown. An electric conductor 2 extends along a road section 3 on which the vehicles travel. Each electric conductor 2 is formed by a plurality of conductor segments, in the figure conductor segments 2a-2d are shown, arranged consecutively along a lengthwise direction of the road section. The conductor segments are electrically isolated from each other. The electrically propellable vehicles 1a-d each comprise at least one electric motor (not shown in the figure, typically arranged as hub motors) arranged to propel the vehicle, an electric energy storage device in the form of a battery set (not shown in the figure, typically arranged in the floor pan of the vehicle) electrically connected with the at least one electric motor and a current collector 4a-d adapted to connect electrically with the at least one electric conductor 2. The current collector being electrically connected to the electric energy storage device via switching means.

The electric conductor and the current collector may be configured as described in SE543629 (which is hereby incorporated by reference), i.e. the electric conductor is arranged in a groove in at least one rail element, the rail element being located in or on the road section 3. The current collector 4a-d is displaceable vertically and laterally and comprises at least one contact element being adapted to connect mechanically and electrically with the conductor segments. The at least one rail element is also provided with an additional electric conductor (not shown) being connected to ground potential. The ground conductor may be provided in a separate groove in the rail element, or in the same groove as the electric conductor, or at the top of the rail element (as a ground shield). The current collector comprises at least one ground contact element, each being configured to be brought in electrical and mechanical contact with the ground conductor. The ground conductor is not segmented in this embodiment.

The system further comprises a plurality of vehicle-external charging devices, in the figure four charging devices 5a-d are shown, each charging device being connected to a respective conductor segment 2a-d and to the above-described (common) ground conductor extending in parallel with the conductor 2 to provide a DC voltage thereto adapted for charging the electric energy storage device of the at least one electrically propellable vehicle.

Charging device control means is provided in the form of a charging device control units 5a-5d′ arranged to control the respective vehicle external charging device 5a-d. The charging device control means being provided with communication means being connected to the electric conductor 2.

Each electrically propellable vehicle 1a-d comprises vehicle control means in the form of a vehicle control unit 1a-d′ provided with communication means in the form of an interface connected to the current collector which is adapted to connect with the communication means of the charging device control means via the conductors to transmit at least one charge signal thereto indicative of at least one charging parameter comprising a desired charging current for the electric energy storage device of the vehicle. The charge signal may correspond to the sum of the maximum allowable charging current of the electric energy storage device of the respective vehicle and a present power required for propulsion of the vehicle.

The charging device control units 5a-5d′ are configured to, in response to the charge signal, order the corresponding charging device 5a-d to provide a current to the thereto connected conductor segment 2a-d corresponding to the desired charging current.

As can be seen in FIG. 1, vehicles 1a, 1b are located at conductor segments 2a, 2c and have thus transmitted respective charge signal to the respective charging device control unit 5a, 5c (via its current collector and the thereto connected conductor segment) and charging devices 5a, 5c consequently provide the desired charging currents to the respective conductor segment. Charging device 5b does, however, not provide any current to conductor segment 2b since no vehicle is present, and thus, no charge signal has been received. In other embodiments, the charge signal is transmitted via wireless communication means, for instance via GSM.

The vehicle control units 1a-1d′ are furthermore each configured to transmit an identification signal indicative of the identity of the vehicle (such as the vehicle's registration number) to the charging device control means. This vehicle identity is used by the charging device control units to approve or disapprove of charging and optionally for billing the cost of the provided electric power to the vehicle owner.

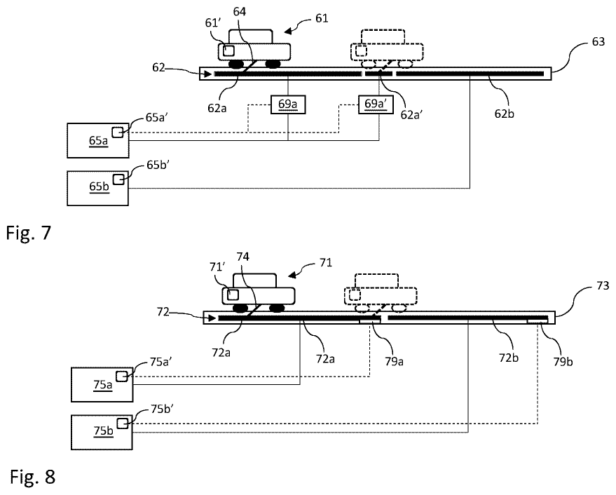

Vehicles 1c, 1d are both located at conductor segment 2d and have thus transmitted respective charge signal to charging device control unit 5d via its current collector and the thereto connected conductor segment. The charging device control units 5a-d are configured to determine a vehicle to receive charging as the vehicle having a current position corresponding to the conductor segment having travelled farthest along the conductor segment, i.e the vehicle which first connected with the conductor segment. The current position of the vehicles may be determined based on a position signal transmitted from the vehicle control units 1a-d′ to the charging device control unit. In other embodiments, the position is determined as explained below with reference to FIG. 7-8. In this example, the vehicle to receive charging is determined to be vehicle 1d since this vehicle has traveled farthest along the conductor segment. The charging device control units 5a-d′ are furthermore configured to order the vehicle charging device connected to the conductor segment to provide a current to the conductor segment corresponding to the charging signal received from the vehicle determined to receive charging (in this example 1d), and to transmit an approval signal to the vehicle communication means (in this example 1d′) of the vehicle determined to receive charging indicating that electric power is provided, wherein the vehicle control means is configured to, in response to said approval signal, switch on the switching means to connect the current collector to the electric energy storage device for charging thereof.

Each charging device may furthermore be configured to measure the voltage provided therefrom to a thereto connected conductor segment, and its corresponding charging device control means may be configured to, if said current provided to said conductor segment from said charging device is above a predetermined value determined as a function of said measured voltage, order the charging device to decrease the current provided to the thereto connected conductor segment to the predetermined value.

It is understood that the charging of vehicles 1a, 1b, 1d takes place while driving, i.e. the charging device control means and the vehicle control means are configured to charge the at least one electrically propellable vehicle while travelling along the road section.

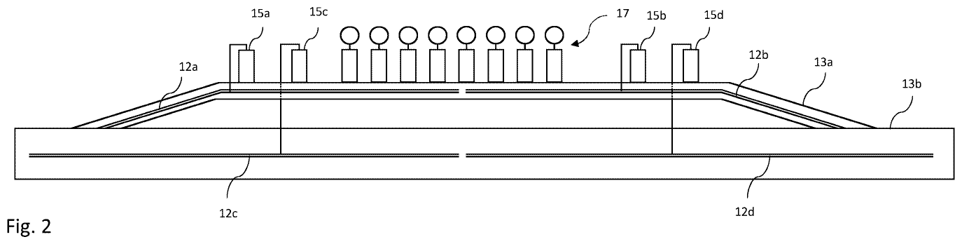

FIG. 2 shows of an embodiment of a system according to the first aspect of the invention, shown without the at least one vehicle. The system corresponds to the system in FIG. 1 in the sense that conductor segments 12c, 12d are provided along a road section 13b, each conductor segment having a charging device 15c, 15d provided with charging device control means in a corresponding manner as in FIG. 1. In FIG. 2 it is however illustrated that additional conductor segments 12a, 12b may be provided along a road section 13a in the form of a turnout/sideroad/lay-by from road section 13b. Road section 13b may be a highway road section or any other type of (lower speed) road section. The conductor segments 12a, 12b are connected to charging devices 15a, 15b provided with charging device control means in a corresponding manner as in FIG. 1. In this embodiment, two parallel conductor segments are shown, where one of the conductor segments may be connected to ground (as in FIG. 1). The at least one vehicle of the system (not shown in FIG. 2) may be of the same type as in FIG. 1. In addition to the conductors 12a-d and associated charging devices, a set of conventional stationary chargers 17 (connectable to the vehicles with cables, for example using the CCS2 standard) are provided at the turnout/sideroad/lay-by. The stationary charges may alternatively be of the type described in WO2021051233 (herby incorporated by reference), i.e. using the same current collector as used for charging from conductor segments 12a-d during driving.

The vehicles of the system in FIG. 2 may thus be charged in three different ways:
1. During driving at normal speed along the road section 13b
2. During driving at reduced speed along road section 13a
3. Stationary when parked at road section 13a

Alternative 2 is particularly advantageous since a relatively large amount of electric energy may be provided to the electric storage devices of the vehicles thanks to the high-power vehicle-external charging devices and the prolonged charging time due to the reduced speed at road section 13a.

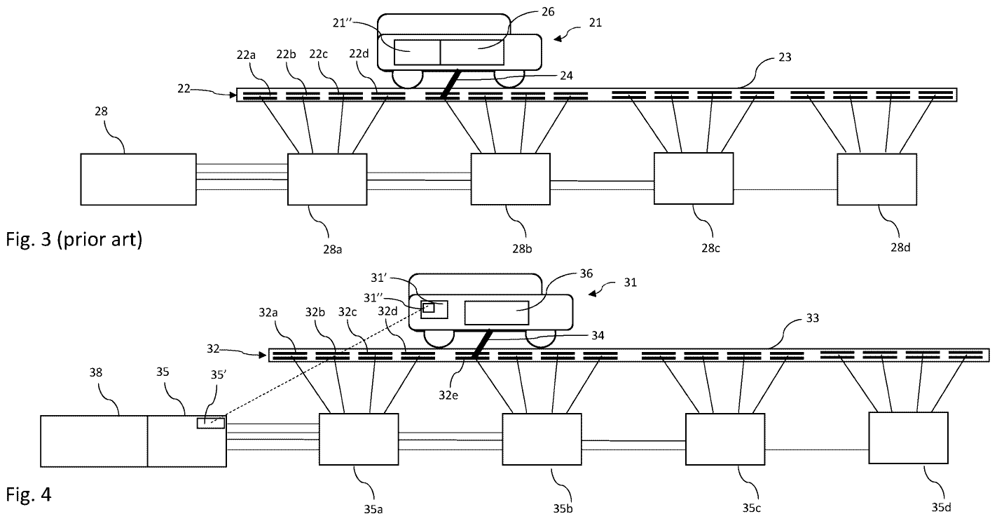

FIG. 3 shows a prior art system of a similar type as described in WO 2011/123049. The system comprises a pair of electric conductors 22 extending along a road section 23 on which the vehicles travel. The electric conductors are each formed by a plurality of conductor segments (22a-d for example) in the same manner as in FIG. 2. A source of electric power 28, which may be referred to as a transformer station) is connected to the conductor segments via switches 28a-d. The source of electric power typically comprises a transformer connected to the electric grid and a rectifier but no vehicle-external charging device. In this prior art system, the vehicles (21 for instance) are provided with an on-board charging device 21″ connected to the current collector (of the same type described above with reference to FIG. 1) and to the battery set 26. When the vehicle is located over a conductor segment, the presence of the vehicle and its current collector is detected (for example in a manner described in applicants previous patent applications), whereby the switch connected to the conductor segment in order to connect the rectified electric power from the power source 28 to the electric conductor. The on-board charger adjusts the charging voltage and/or current appropriately to the battery set.

FIG. 4 shows an embodiment of a system according to the first aspect of the invention. FIG. 4 illustrates some of the differences between the present invention in relation to the prior art system shown in FIG. 3, the main difference being that the system is provided with a set of vehicle-external charging devices 35 rather than on-board chargers. As can be seen in FIG. 4, the electric conductors 32 and the current collector 34 are formed in the same manner as in FIG. 3. The source of electric power 38 corresponds to ref. 28 in FIG. 3. A set of vehicle-external charging devices 35 is connected to the source of electric power 38, and the charging devices are in turn each connected to four conductor segments (32a-d for example) via switching devices (35a for example), which may be considered part of the respective charging device. The set of charging devices 35 is provided with charging device control means 35′, either in the form of a common charging device control unit for all charging devices, or a charging device control unit for each charging devices.

Each electrically propellable vehicle (31 for example) comprises vehicle control means in the form of a vehicle control unit 31′ provided with wireless communication means 31″ which is adapted to connect with communication means of the charging device control means 35′for instance via GSM/3G/4G/5G to transmit at least one charge signal thereto indicative of at least one charging parameter comprising a desired charging current for the electric energy storage device 36 of the vehicle. The charge signal may correspond to the sum of the maximum allowable charging current of the electric energy storage device of the respective vehicle and a present power required for propulsion of the vehicle.

The charging device control means 35′ is configured to, in response to the charge signal, order the corresponding charging device via the corresponding switch to provide a current to the thereto connected conductor segment corresponding to the desired charging current.

The vehicle control means 31′ of each vehicle may furthermore be configured to, over its vehicle communication means 31″, transmit a position signal to the charging device control means 35′, which may be configured to use the position signal to determine which conductor segment is to be ordered to provide the desired charging current. The charging device control means 35′ may be configured to determine a current position of each vehicle being connected to the at least one electric conductor based on said position signal, as part of the determining. In other embodiments, the position is determined as explained below with reference to FIG. 7-8.

As can be seen in FIG. 4, vehicle 31 and its current collector 34 is located at conductor segment 32e. Based on a charge signal and optional position signal (or using otherwise determined position) transmitted from vehicle control unit 31′ via communication means 31″ to charging device control means 35, a charging device of set 35 provides the desired charging current conductor segment 32e via switching device 35b (which is also controlled in response to the determined position). In this example, none of the other conductor segments are provided with current.

The vehicle control units (31′ for example) may furthermore be configured to transmit an identification signal in a corresponding manner as described above with reference to FIG. 1.

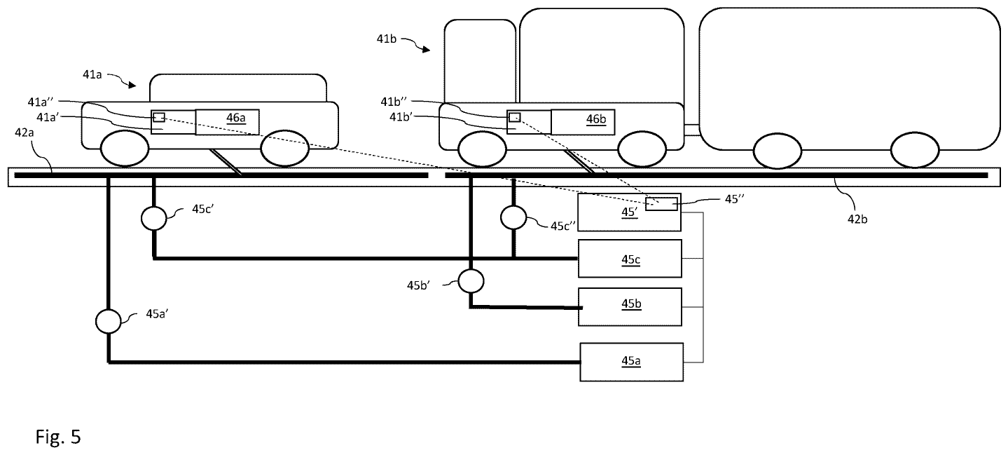

FIG. 5 shows an embodiment of a system according to the first aspect of the invention. In this embodiment, the electric conductor is schematically illustrated as comprising two subsequent conductor segments 42a, 42b (which may each be pairs of electric conductor segments, or a single conductor segment complemented by a ground conductor as in FIG. 1).

A first sub-set of vehicle external charging devices (45a, 45b for example) are each connected solely to one (pair of) respective conductor segment 42a, 42b. A second sub-set of vehicle external charging devices (45c for example) are each connected to two or more (pairs of) respective conductor segments (42a, 42b). In this embodiment, the maximum charging power of the second sub-set of said plurality of vehicle external charging devices is higher than the maximum charging power of the first sub-set of said plurality of vehicle external charging devices. This allows light vehicles (41a for example) to be charged from each conductor segment, while heavy vehicles (41b for example) cannot (which is normally not required due to fewer heavy vehicles).

The vehicle control means 41a′ of each vehicle may furthermore be configured to, over its vehicle communication means 31″, transmit a position signal to the charging device control means 35′, which may be configured to use the position signal to determine which conductor segment is to be ordered to provide the desired charging current. The charging device control means 45′ may be configured to determine a current position of each vehicle being connected to the at least one electric conductor based on said position signal, as part of the determining. In other embodiments, the position is determined as explained below with reference to FIG. 7-8.

As can be seen in FIG. 5, vehicle 41a and its current collector is located at conductor segment 42a. Based on a charge signal and optional position signal (or using otherwise determined position) transmitted from vehicle control unit 41a′ via communication means 41a″ to charging device control means 45, charging device 45a provides the desired charging current conductor segment 42a via switching device 45a′ (which is also controlled in response to the determined position).

Further, vehicle 41b and its current collector is located at conductor segment 42b. Based on a charge signal (indicating a high desired charge current) and optional position signal (or using otherwise determined position) transmitted from vehicle control unit 41b′ via communication means 41b″ to charging device control means 45, charging device 45c provides the desired charging current to conductor segment 42b via switching device 45c″ (which is also controlled in response to the determined position).

In other embodiments, the charge signal is transmitted via the current collector and the conductor segments, which makes transmitting the position signal optional since the charging device control means can determine from which conductor the charge signal is received.

The vehicle control units (41a′ for example) may furthermore be configured to transmit an identification signal in a corresponding manner as described above with reference to FIG. 1.

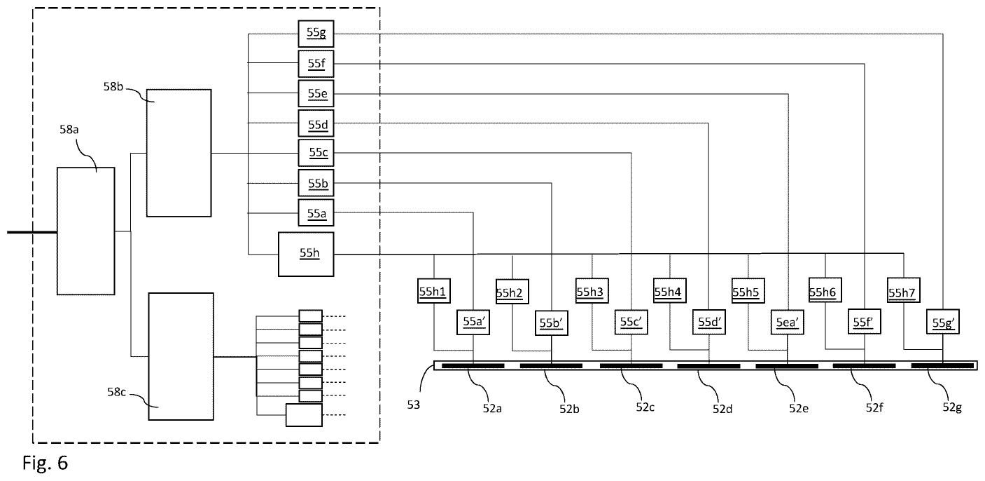

FIG. 6 shows an embodiment of a system according to the first aspect of the invention, the system being provided with a first sub-set of charging devices 55a-g each connected solely to one (pair of) conductor segment(s) 52a-g (arranged along road section 53) via switching devices 55a′-g′ and a second sub-set of charging devices comprising a (higher power) charging device 55h connected to a plurality of subsequent (pairs of) conductor segments(s) 52a-g via switching devices 55h1-h7. The system is shown without the at least one vehicle. The embodiment in FIG. 6 is similar to the embodiment in FIG. 5, but illustrates the system on a larger scale. The charging devices 55a-h are arranged in a transformer station (indicated by dotted lines) also comprising a transformer 58a connected to the grid and rectifiers 58b-c. The transformer station also comprises additional first and second sets of charging devices connected to rectifier 58c and to conductor segments of another (subsequent) road section (not shown). It is understood that the system comprises charging device control means in a corresponding manner as described above with reference to FIG. 5.

FIG. 7 shows an embodiment of a system according to the first aspect of the invention, wherein the electric conductor comprises a short conductor segment arranged between two longer conductor segments for positioning purposes.

FIG. 8 shows an embodiment of a system according to the first aspect of the invention, wherein the electric conductors each comprise one or more coils arranged at an end position of the conductor segments for positioning purposes.

The vehicle control means 61′/71′ of each vehicle (61/71 for example) is configured to transmit an identification signal indicative of the identity of the vehicle to the charging device control means 65a′/75a′, 65b′/75b′. The identity may be a unique identification number of the vehicle such as a registration number or a chassis number. Alternatively, the identity may be an identification number assigned by the charging device control means to the respective vehicle. The identification signal may be used for authenticating that the vehicle is permitted to receive charging, or for billing purposes. The current collector 64/74 is provided with transmitting means, and at least one conductor segment 62a/72a is provided with receiving means. In FIG. 7, the receiving means is formed by a separate conductor segment 62a′ arranged immediately subsequently after the conductor segment 62. In FIG. 8, the receiving means is formed by one or more coils 79a arranged at an end position of conductor segment 72a. The receiving means are thus in both cases arranged at predetermined positions, and in both cases have a short length compared to the overall length of the corresponding conductor segment 62a/72a.

The identification signal is transmitted from the vehicle control means to the charging device control means via the transmitting means and said receiving means. The vehicle control means 61′/71′ is configured to, over its vehicle communication means, transmit a speed signal indicative of the speed at which the vehicle is travelling to the charging device control means 65a′/75a′. The charging device control means is configured to determine an initial position of a vehicle being connected to the at least two conductor segments based on the respective predetermined position of the conductor segment 62a′/one or more coils 79a and determine a current position of each vehicle being connected to the at least two electric conductors based on said initial position and said speed signal.

The description above and the appended drawings are to be considered as non-limiting examples of the invention. The person skilled in the art realizes that several changes and modifications may be made within the scope of the invention. In particular, the number of conductors, conductor segments, vehicles, charging devices, the number of conductor segments connected to respective charging device may be varied from the exemplary numbers provided in the embodiments above. Furthermore, in embodiments where communication between the vehicle control means and charging device control means is described as wired (via the electric conductor(s)), the communication means may be replaced with wireless communication means and vice versa.

1. A system comprising:
at least one electrically propellable road vehicle; and
at least two electric conductors extending along a road section on which the road vehicle is adapted to travel,
wherein at least one of the electric conductors is formed by at least two conductor segments arranged consecutively along a lengthwise direction of the road section, said conductor segments being electrically isolated from each other,
wherein the at least one electrically propellable vehicle comprises at least one electric motor arranged to propel the vehicle, an electric energy storage device electrically connected with the at least one electric motor and a current collector adapted to connect electrically with said at least two electric conductors, the current collector being electrically connected to the electric energy storage device, the system further comprising:
at least two vehicle external charging devices being connected to two or more of the electric conductors, to provide a voltage thereto adapted for charging the electric energy storage device of the at least one electrically propellable vehicle, each charging device being connected to one or more conductor segment, and
charging device control means configured to control the at least two vehicle external charging device said charging device control means being provided with communication means,
wherein the at least one electrically propellable vehicle comprises vehicle control means and communication means adapted to connect with the communication means of the charging device control means to transmit at least one charge signal thereto indicative of at least one charging parameter comprising a desired charging current for the electric energy storage device of the vehicle, and
wherein the charging device control means is configured to, in response to said at least one charge signal, order one or more of the at least two vehicle external charging devices to provide a current to the thereto connected conductor segment or conductor segments corresponding to the desired charging current.

2. The system according to claim 1, wherein said communication means of the charging device control means and said vehicle communication means are wireless communication means.

3. The system according to claim 1, wherein said communication means of the charging device control means is connected to the at least two electric conductors and wherein said vehicle communication means is connected to the current collector.

4. The system according to claim 1, wherein all or a sub-set of said vehicle external charging devices are each connected solely to one respective conductor segment having a corresponding position in a lengthwise direction of the road section.

5. The system according to claim 1, wherein a first sub-set of said plurality of vehicle external charging devices are each connected solely to one respective conductor segment having a corresponding position in a lengthwise direction of the road section, and wherein a second sub-set of said plurality of vehicle external charging devices are each connected to two or more respective conductor segments having different positions in a lengthwise direction, wherein a maximum charging power of the first sub-set of said plurality of vehicle external charging devices differs from a maximum charging power of the second sub-set of said plurality of vehicle external charging devices.

6. The system according to claim 1, wherein each vehicle control means is configured to transmit an identification signal indicative of an identity of the vehicle to the charging device control means.

7. The system according to claim 6, wherein each current collector is provided with transmitting means and wherein at least one conductor segment is provided with receiving means,
wherein the identification signal is transmitted from the vehicle control means to the charging device control means via said transmitting means and said receiving means,
wherein the receiving means is arranged at a predetermined position relative to the conductor segment, and
wherein the vehicle control means is configured to, over its vehicle communication means, transmit a speed signal indicative of the speed at which the vehicle is travelling to the charging device control means,
wherein the charging device control means is configured to determine an initial position of a vehicle being connected to the at least two electric conductors based on the respective predetermined position and determine a current position of each vehicle being connected to the at least two electric conductors based on said initial position and said speed signal.

8. The system according to claim 6, wherein the vehicle control means of each vehicle is furthermore configured to, over its vehicle communication means, transmit a position signal to said charging device control means, which is configured to determine a current position of each vehicle being connected to the at least two electric conductors based on said position signal.

9. The system according to claim 7, comprising at least two electrically propellable vehicles, wherein the current collector is electrically connected to the electric energy storage device via switching means, wherein the charging device control means is configured to
determine, for each conductor segment, a vehicle to receive charging as the vehicle having a current position corresponding to the conductor segment having travelled farthest along the conductor segment;
order a vehicle charging device connected to the conductor segment to provide a current to the conductor segment corresponding to the charging signal received from the vehicle determined to receive charging; and
transmit an approval signal to the vehicle communication means of the vehicle determined to receive charging indicating that electric power is provided, wherein the vehicle control means is configured to, in response to said approval signal, switch on the switching means to connect the current collector to the electric energy storage device for charging thereof.

10. The system according to claim 9, wherein the vehicle control means is furthermore configured to, via its vehicle communication means, transmit a charge status signal indicative of a current charge status of the electric energy storage device to the charging device control means, and
wherein the charging device control means is configured to determine, in response to received charge status signals from two or more vehicles having positions corresponding to the same conductor segment, a set of vehicles which have a current charge status below a predetermined value, wherein said vehicle to receive charging is determined as the vehicle of said set of vehicles having travelled farthest along the conductor segment.

11. The system according to claim 1, wherein each charging device is configured to measure the voltage provided therefrom to a thereto connected conductor segment, and wherein said charging device control means is configured to, if said current provided to said conductor segment from said charging device is above a predetermined value determined as a function of said measured voltage, order the charging device to decrease the current provided to the thereto connected conductor segment to the predetermined value.

12. The system according to claim 1, wherein the vehicle control means is configured to transmit a charge signal corresponding to a sum of a maximum allowable charging current of the electric energy storage device and a present power required for propulsion of the vehicle.

13. The system according to claim 1, wherein said charging device control means and said vehicle control means of at least one electrically propellable vehicle are configured to charge the at least one electrically propellable vehicle while travelling along said road section, and during standstill.

14. The system according to claim 1, wherein one or more of the at least two electric conductors is connected to ground potential.

15. A method for providing electric power to at least one electrically propellable road vehicle from at least two electric conductors extending along a road section on which the road vehicle is adapted to travel,
wherein at least one electric conductor is formed by at least two conductor segments arranged consecutively along a lengthwise direction of the road section, said conductor segments being electrically isolated from each other,
wherein the at least one electrically propellable vehicle has at least one electric motor arranged to propel the vehicle, an electric energy storage device electrically connected with the at least one electric motor and a current collector being electrically connected to the electric energy storage device, the current collector being adapted to connect electrically with said at least two electric conductors,
wherein at least two vehicle external charging devices are connected to two or more electric conductors to provide a voltage thereto adapted for providing electric power to the at least one electrically propellable vehicle, each charging device being connected to one or more conductor segment, the method comprising:
determining a desired charging current for one or more of the at least one electrically propellable road vehicle being, and
ordering one or more of the at least two vehicle external charging devices to provide a current to the thereto connected conductor segment or conductor segments corresponding to the desired charging current.
